(19) United States
(12) Patent Application Publication
(10) Pub. No.: US 2016/0299740 A1
(43) Pub. Date: Oct. 13, 2016

(54) METHOD OF CONTROLLING PLAY AND TERMINAL

(71) Applicant: Guang Dong Oppo Mobile Telecommunications Corp. Ltd., Dongguan City (CN)

(72) Inventor: Hao Huang, Dongguan City (CN)

(73) Assignee: Guang Dong Oppo Mobile Telecommunications Corp., Ltd., Dongguan City (CN)

(21) Appl. No.: 15/186,564

(22) Filed: Jun. 20, 2016

Related U.S. Application Data
(63) Continuation of application No. PCT/CN2015/097628, filed on Dec. 16, 2015.

(30) Foreign Application Priority Data
Mar. 31, 2015 (CN) 201510150189.7

(51) Int. Cl. G06F 3/16; H04M 1/725; G10L 25/48; G06F 3/0484; G06F 3/0482; H04W 12/02; G06F 3/0488

(52) U.S. Cl. CPC G06F 3/165; H04W 12/02; H04M 1/72577; G06F 3/04883; G06F 3/04847; G06F 3/0482; G06F 3/167; G10L 25/48; H04W 88/02

(57) ABSTRACT

The present disclosure proposes a method of controlling play and a terminal. The method includes: detecting a first sliding track inputted into an interface of the equipment list; extracting equipment identifications included in equipment identification areas where the first sliding track passes through; generating a target equipment group including the equipment identifications; receiving voice messages to the target equipment group and analyzing the voice messages so to extract a duration and speed of the voice messages; sending a play command including the duration and speed of the voice to the equipment of the equipment identifications, so to control the equipment to start timing when receiving the play command, and start playing songs at the speed when the timing duration reaches the voice duration. The present disclosure synchronizes the playing of songs of playing equipments included in the same equipment group, and enhances the effect when listening to the songs.

### CROSS REFERENCE TO RELATED APPLICATIONS

This application is a continuation application of PCT application No. PCT/CN2015/097628, filed on Dec. 16, 2015. The PCT application claims the benefit and priority of Chinese Application No. 201510150189.7, filed on Mar. 31, 2015. The entire disclosures of each of the above applications are incorporated herein by reference.

### BACKGROUND OF THE DISCLOSURE

1. Field of the Disclosure

The present disclosure relates to smart terminal technology, and more specifically, to a method of controlling play and a terminal.

2. Description of the Related Art

As people's living quality elevates, people attach more importance on mental enjoyment. At times of festivals or holidays, music playing equipment (such as speakers) are often configured at home to create a lively ambiance. To enhance musical effects, a plurality of music playing equipment is often configured. However, practical experiences showed that when a plurality of playing equipment is configured to play the same songs, even if the user has configured parameters concerning playing (e.g. time or speed) to the same benchmarks and these playing equipment start playing the songs at the same time, they cannot play the songs at the same speed because each has an independent clock. When they are playing the same songs at the same time, listeners hear echoes.

In order to more clearly illustrate the embodiments of the present disclosure or related art, the following figures will be described in the embodiments are briefly introduced. It is obvious that the drawings are merely some embodiments of the present disclosure, those of ordinary skill in this field can obtain other figures according to these figures without paying the premise.

### BRIEF DESCRIPTION OF THE DRAWINGS

FIG. 1 is a flowchart of a method of controlling play according to an embodiment of the present disclosure.

FIG. 2 shows different sliding tracks inputted into an interface of an equipment list according to the embodiment of the present disclosure.

FIG. 3 is a flowchart of another method of controlling play according to another embodiment of the present disclosure.

FIG. 4 is a flowchart of still another method of controlling play according to still another embodiment of the present disclosure.

FIG. 5 is a block diagram of a terminal according to a first embodiment of the present disclosure.

FIG. 6 is a block diagram of another terminal according to a second embodiment of the present disclosure.

FIG. 7 is a block diagram of still another terminal according to a third embodiment of the present disclosure.

### DETAILED DESCRIPTION OF THE PREFERRED EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

The embodiments of the present disclosure propose a method of controlling play and terminal that can divide a plurality of playing equipment into different groups and synchronize the playing of songs of a plurality of playing equipment included in an equipment group, so to enhance the effect when listening to the songs. The following text explains each embodiment in detail.

A terminal referred to in the embodiments of the present disclosure can include but is not limited to smart phone, tablet, notebook, personal digital assistant (PDA) or other device. The operation system (OS) of the terminal can include but is not limited to Android, IOS, Symbian OS, Black Berry OS and Windows Phone 8. The embodiments of the present disclosure do not require any specific type of the terminal or OS.

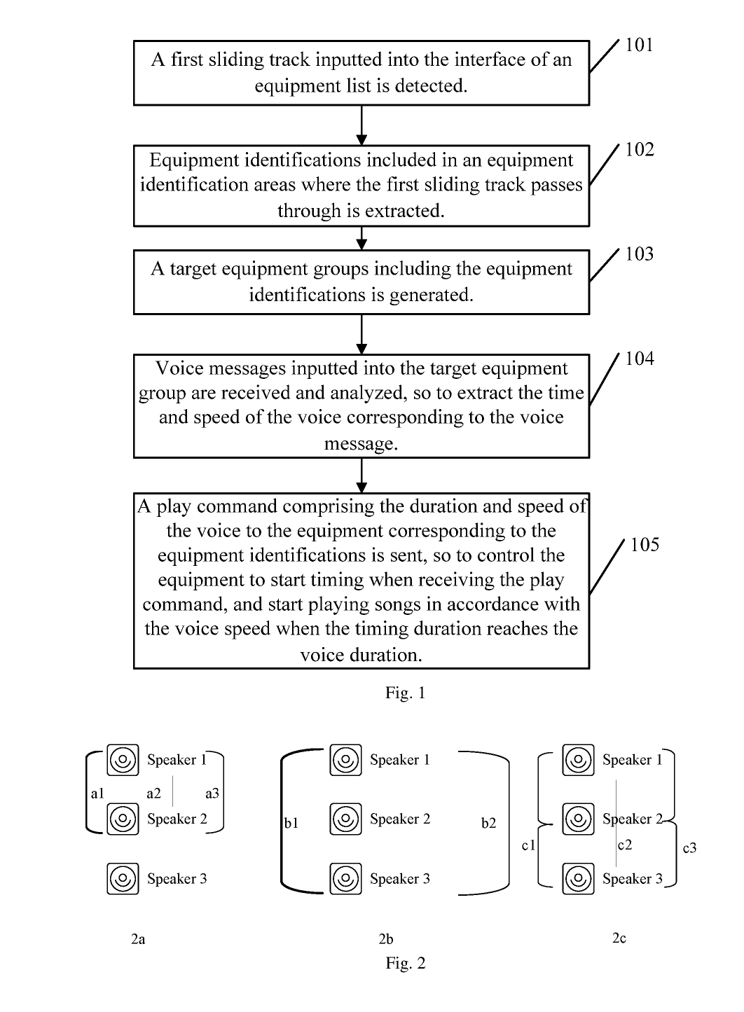

Please refer to FIG. 1. FIG. 1 is a flowchart of a method of controlling play according to an embodiment of the present disclosure. The method includes the followings.

At block 101, a first sliding track inputted into the interface of an equipment list is detected.

In at least one embodiment, before the first sliding track inputted into the interface of the equipment list is detected, the terminal detects a touch operation of a target touch point on the interface of the equipment list. When the duration of the touch operation is detected to exceed a predetermined time threshold, an equipment grouping command is generated. Then the terminal, in response to the equipment grouping command, detects the first sliding track inputted into the interface of the equipment list that starts from the target touch point. In at least one alternative embodiment, after the equipment grouping command is generated, the terminal can also detect the first sliding track inputted into the interface of the equipment list that starts from any point other than the targeted touch point as the starting point.

In the illustrated embodiments of the present disclosure, the terminal enters into the interface of the equipment list so to detect the first sliding track inputted into the interface of the equipment list.

In at least one alternative embodiment, the method can further include the followings before the first sliding track inputted into the interface of the equipment list is detected. An enabling command for the equipment list is received. The interface of the equipment list is enabled in response to the enabling command for the equipment list. In at least one embodiment, that the enabling command for the equipment list is received and the interface of the equipment list is enabled may be implemented through the following: receive an enabling command for the equipment list; output a prompting message that is configured for requesting the input of a message pending verification; receive the inputted message pending verification in response to the prompting message; verify whether the message pending verification is the same as a predetermined verification message; if the message pending verification is the same as the predetermined verification message, then the interface of the equipment list enables in response to the enabling command for the interface of the equipment list.

In at least one embodiment, when the terminal receives the enabling command for the equipment list, the terminal outputs a prompting message to request the input of the message pending verification. And, the terminal can output an input box to be configured to input message pending verification.

In at least one embodiment, the message pending verification can include but is not limited to, one or a combination of several of the following information, including password pending verification, fingerprint data pending verification, facial feature data pending verification, iris data pending verification, retina data pending verification, and voiceprint data pending verification.

In at least one embodiment, the predetermined verification message can include but is not limited to one of or a combination of several of the following information, such as predetermined verification password, predetermined fingerprint data, predetermined facial feature data, predetermined iris data, predetermined retina data and predetermined voiceprint data.

In at least one embodiment, the abovementioned predetermined verification message can include fingerprint string data and an input timing corresponding to each fingerprint. Accordingly, verifying whether the message pending verification is the same as the predetermined verification message can include following steps:

Detect whether the fingerprint string is the same as the fingerprint included in the predetermined verification message and whether intervals between input timings of the same fingerprints are smaller than the predetermined value. If the detect shows that the fingerprint strings are the same as the fingerprint strings included in the predetermined verification message, and the intervals between input timings of the same fingerprints are smaller than the predetermined value, then it means that the message pending verification is the same as the predetermined verification message. If not, then it means that the message pending verification is not the same as the predetermined verification message. Implementing the present embodiment can prevent an illegal user from enabling the interface of equipment list on the terminal and command the interface at their will.

In the present embodiment, the terminal can detect the first sliding track inputted into the interface of the equipment list after entering into the interface of the equipment list.

Please also refer to FIG. 2. FIG. 2 shows different sliding tracks inputted into the interface of the equipment list according to the embodiment of the present disclosure. A first sliding track can be a regular sliding track, such as track a2 shown in part 2a of FIG. 2, and track c2 shown in part 2c of FIG. 2. It can also be a curved sliding track, such as tracks a1 and a3 shown in part 2a of FIG. 2, tracks b1 and b2 shown in part 2b of FIG. 2, and tracks c1 and c3 shown in part 2c of FIG. 2.

At block 102, equipment identifications included in equipment identification areas where the first sliding track passes through is extracted.

Please note that the sliding track in block 101 can include but is not limited to the sliding tracks respectively shown in parts 2a, 2b and 2c in FIG. 2. Any sliding track that passes through the equipment identification areas is within the scope of the present disclosure.

In the present embodiment, all equipment identifications are shown in the equipment identification areas. The equipment identifications include an exclusive string of alphabets or numbers configured to identify the equipment. Each equipment has one, and only one identification. The equipment identification can be a user's nickname or contact information, the international mobile equipment identity (IMEI) of the equipment, MAC address, or equipment ID. The present embodiment does not impose any specific requirement here.

In the present embodiment, when a user inputs a first sliding track into the interface of the equipment list, the first sliding track will pass areas corresponding to some equipment identifications which the terminal can extract. For example, in FIG. 2, equipment identifications included in areas where sliding tracks a1, a2, and a3 shown in part 2a pass through are speaker 1 and speaker 2; equipment identifications included in areas where sliding tracks b1 and b2 in part 2b pass through are speaker 1 and speaker 3; and equipment identifications included in areas where sliding tracks c1, c2 and c3 in part 2c pass through are speaker 1, speaker 2 and speaker 3.

Please note that the equipment identification areas only take part of the interface of the equipment list. This part can be divided evenly according to the amount of the equipment identifications, so that each equipment identification only accounts for a sub-area on the interface after the division. When the user is scrolling down the interface of the equipment list, the sub-area of an equipment identification can be skipped. For example, in FIG. 2, both sliding tracks b1 and b2 in part 2b circumvent the sub-area of speaker 2, meaning that the equipment identification areas that b1 and b2 pass through do not include speaker 2.

In at least one alternative embodiment, after a first sliding track inputted into the interface of an equipment list is detected, and before equipment identifications included in equipment identification areas where the first sliding track passes through is extracted, the terminal further implements the followings: detecting whether the first sliding track inputted into the interface of the equipment list is over, if yes, implementing block 102; if no, implement block 101.

In the present embodiment, when the terminal detects that the first sliding track inputted into the interface of the equipment list is over, the terminal can extract all equipment identifications included in the equipment identification areas where the first sliding track passes through.

At block 103, a target equipment group is generated.

In at least one embodiment, the target equipment group generated by the terminal includes all equipment identifications extracted in block 102. That is, equipment corresponding to these equipment identifications are grouped into the target equipment group. For example, in FIG. 2, equipment identifications of speaker 1 and speaker 2 included in areas where sliding tracks a1, a2 and a3 in 2a passed through can generate a target equipment group; equipment identifications of speaker 1 and speaker 2 included in areas where sliding tracks b1 and b2 in 2b passed through can generate a target equipment group; equipment identifications of speaker 1, speaker 2 and speaker 3 included in areas where sliding tracks c1, c2 and c3 in 2c passed through can generate a target equipment group.

In at least one embodiment, when the target equipment group is generated, the terminal can output the target equipment group in the interface of the equipment list. The target equipment group is shown at a position before ungrouped equipment identification(s).

At block 104, voice messages inputted into the target equipment group are received and analyzed, so to extract the time and speed of the voice corresponding to the voice messages.

In at least one embodiment, after the terminal generates the target equipment group, the terminal can receive voice messages inputted to the target equipment group. Furthermore, the terminal analyzes the voice messages so to extract the duration and speed of the voice corresponding to the voice messages.

For example, the terminal enables an audio receiving equipment and receives song(s) that the user sung to the target equipment group. Then, the terminal can further analyze audio data of the song so to extract the duration and speed of the audio data. If a song is five minutes long and has a speed of 1 Mb/s, then after the analysis, the five minutes will be taken as the duration of the voice and 1 Mb/s as the speed of the voice.

At block 105, a play command including duration and speed of the voice is sent to equipment corresponding to equipment identifications, so to control the equipment to start timing when receiving the play command, and the song is stated playing in accordance with the voice speed when the timing duration is the same as the voice duration.

In at least one embodiment, after the terminal extracts the duration and speed of the voice, the terminal can send a play command to equipments corresponding to the equipment identifications. The play command includes the duration and speed of the voice. Upon receiving the play command, the equipment enables a timer to count time. When the timing duration is the same as the voice duration, the equipment start to play the song in accordance with the voice speed. The initial value of the timer is 0.

For example, if the duration of the voice is five minutes and the speed of the voice is 1 Mb/s, and the time when the equipment receives the play command is 11 AM, then the equipment will start playing the song from 11:05 AM at a speed of 1 Mb/s.

According to the method disclosed in FIG. 1, a terminal detects a first sliding track inputted into an interface of an equipment list, and extracts equipment identifications included in the equipment identification areas that the first sliding track passes through, so to generate a group of target equipment. Furthermore, voice messages that are inputted to the target equipment group are received and analyzed so to extract the duration and speed of the voice corresponding to the voice messages. Then, a play command including the duration and speed of the voice is sent to the equipment corresponding to the equipment identifications, so to control the equipment to start timing when receiving the play command, and start playing songs in accordance with the voice speed when the timing duration reaches the voice duration. The terminal of the embodiments of the present disclosure, after dividing the equipment in the equipment list into groups and generating a target equipment group, can control the equipment in the target equipment group to start timing when receiving the play command, and start playing songs in accordance with the voice speed when the timing duration reaches the voice duration. The terminal synchronizes the playing of songs of a plurality of playing equipment included in the same equipment group, and enhances the effect when listening to the songs.

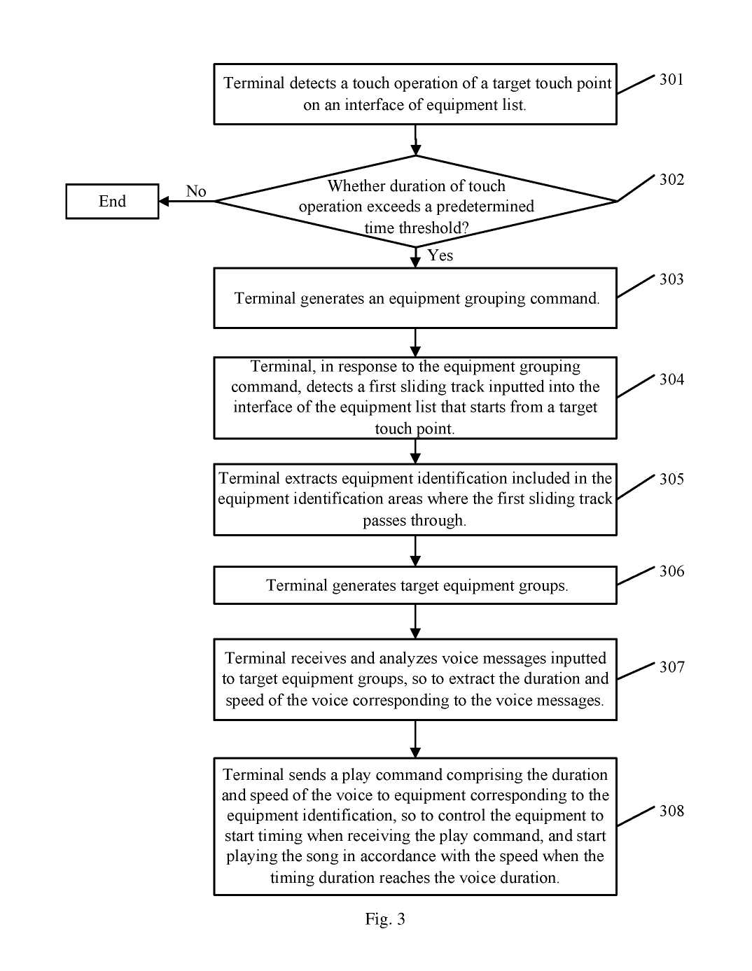

Please refer to FIG. 3. FIG. 3 is a flowchart of another method of controlling play according to another embodiment of the present disclosure. The method includes the followings.

At block 301, the terminal detects touch operation of a target touch point on the interface of the equipment list.

In at least one embodiment, the location of target touch point can be any point on the interface of the equipment list, such as any point outside or inside the equipment identification area. The present disclosure does not specify any location where the target touch point must be at.

At block 302, the terminal detects whether the duration of the touch operation exceeds a predetermined time threshold. If yes, the terminal would implement block 303; if no, the terminal would end this procedure.

In at least one embodiment, the terminal detects the duration of the touch operation of target touch point on the interface of the equipment list conducted by the user, and determines whether the duration exceeds the predetermined time threshold. The predetermined time threshold can be one, two or three seconds. The present disclosure does not specify a particular duration. If the duration of the touch operation exceeds the predetermined time threshold, block 303 is performed. If the duration of the touch operation does not exceed the predetermined time threshold, then the terminal would end this procedure.

As an alternative embodiment, if the duration of the touch operation does not exceed the predetermined time threshold, the terminal can continue to detect the touch operation of the target touch point on the interface of the equipment list.

At block 303, the terminal generates an equipment grouping command.

In the embodiment of the present disclosure, when the terminal detects that the duration of the touch operation exceeds the predetermined time threshold, the terminal can generate an equipment grouping command and prevent grouping triggered by a mistake made by the user on the interface of the equipment list.

At block 304, the terminal, in response to the equipment grouping command, detects a first sliding track inputted into the interface of the equipment list that starts from a target touch point.

In at least one embodiment, after the terminal receives the equipment grouping command, the terminal can detect the first sliding track inputted by the user into the interface of the equipment list that starts from the target touch point. When the terminal detects that the first sliding track inputted by the user is over, the terminal can implement block 305.

At block 305, the terminal extracts equipment identifications included in the equipment identification areas where the first sliding track passes through.

At block 306, the terminal generates a target equipment group.

At block 307, the terminal receives and analyzes voice messages inputted to target equipment group, so to extract the duration and speed of the voice corresponding to the voice messages.

At block 308, the terminal sends a play command including the duration and speed of the voice to equipment corresponding to the equipment identifications, so to control the equipment to start timing when receiving the play command, and start playing the song in accordance with the voice speed when the timing duration reaches the voice duration.

In the flowchart of the method described in FIG. 3, the terminal must detect the touch operation of the target touch point on the interface of the equipment list, and detect whether the duration of the touch operation exceeds the predetermined time threshold. If yes, the terminal would generate an equipment grouping command and, as a response to the equipment grouping command, detect the first sliding track inputted into the interface of the equipment list that starts from the target touch point. The terminal extracts the equipment identifications included in the equipment identification areas where the first sliding track passes through and generates a target equipment group. Furthermore, the terminal receives and analyzes voice messages inputted to the target equipment group, so to extract the duration and speed of the voice corresponding to the voice message. Then the terminal sends a play command including the duration and speed of the voice to equipment corresponding to equipment identifications, so to control the equipment to start timing when receiving the play command, and start playing the song in accordance with the voice speed when the timing duration reaches the voice duration. The embodiment of the present disclosure can prevent grouping of equipment identification triggered by a mistake made by the user on the interface of the equipment list.

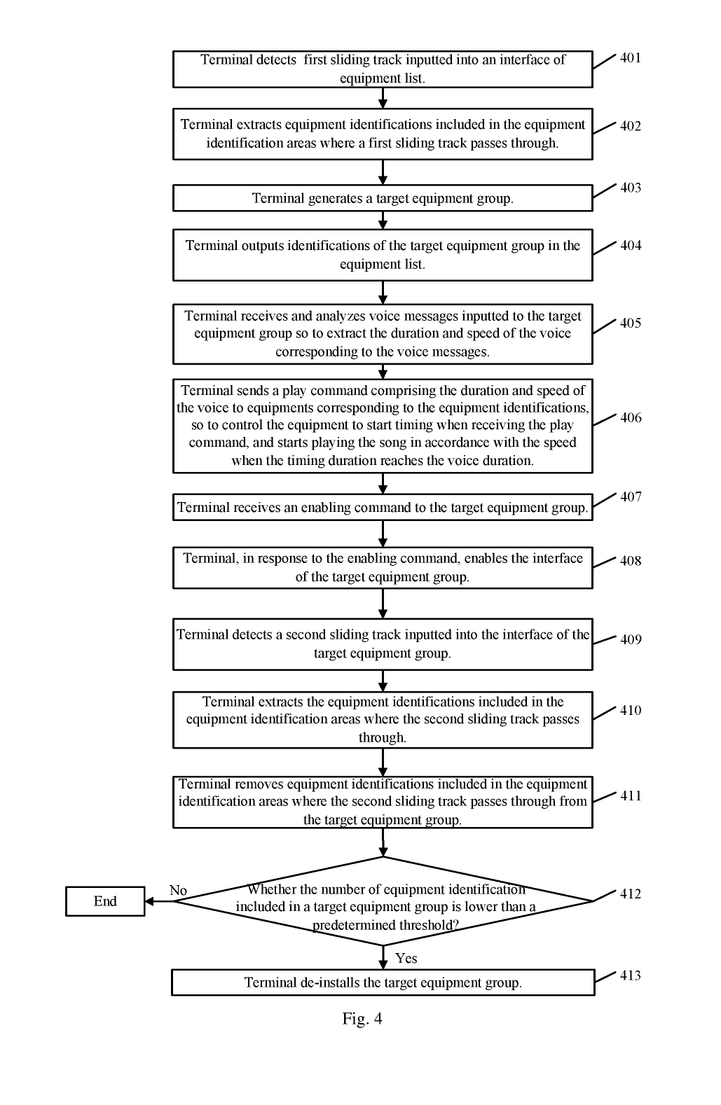

Please refer to FIG. 4. FIG. 4 is a flowchart of another method of controlling play according to another embodiment of the present disclosure. The method includes following blocks.

At block 401, the terminal detects the first sliding track inputted into the interface of the equipment list.

At block 402, the terminal extracts equipment identifications included in the equipment identification areas where a first sliding track passes through.

At block 403, the terminal generates a target equipment group.

At block 404, the terminal outputs the identifications of the target equipment group in the equipment list.

In at least one embodiment, the position of the target equipment group is prior to the ungrouped equipment identification in the equipment list.

At block 405, the terminal receives and analyzes voice messages inputted to target equipment group so to extract the duration and speed of the voice corresponding to the voice messages.

At block 406, the terminal sends a play command including the duration and speed of the voice to equipment corresponding to the equipment identification, so to control the equipment to start timing when receiving the play command, and start playing the song in accordance with the voice speed when the timing duration reaches the voice duration.

At block 407, the terminal receives an enabling command for the target equipment group.

In at least one embodiment, the enabling command can be triggered through an operation command inputted by the user, such as a click made by the user on the identification of the target equipment group.

At block 408, the terminal, in response to the enabling command, enables the interface of the target equipment group.

In at least one embodiment, when the terminal receives an enabling command to a target equipment group, the terminal can enable the interface of the target equipment group in response to the enabling command. On the interface of the target equipment group, the user can see all the equipment identifications included in the target equipment group.

As an alternative embodiment, after the terminal, in response to the enabling command, enables the interface of the target equipment group, the terminal can further implement followings: the terminal detects the touch operation of target touch point on the interface of the target equipment group, the terminal detects whether the duration of the touch operation exceeds a predetermined time threshold, and the terminal generates an equipment removal command upon the duration of the touch operation in excess of the predetermined time threshold.

In at least one embodiment, the terminal can detect the touch operation of the target touch point on the interface of the target equipment group. When the terminal detects that the duration of the touch operation exceeds the predetermined time threshold, the terminal first generates an equipment removal command and then triggers the implementation of block 409, so to prevent a removal of equipment triggered by a mistake made by the user on the interface of the target equipment group.

At block 409, the terminal detects a second sliding track inputted into the interface of the target equipment group.

In the embodiment of the present disclosure, after the terminal enables the interface of a target equipment group, the terminal can detect the second sliding track inputted into the interface of the target equipment group. The procedure of implementing block 409 is the same as that of implementing block 101 in embodiment 1, so no further explanation is provided herein.

At block 410, the terminal extracts the equipment identifications included in the equipment identification areas where the second sliding track passes through.

In at least one embodiment, the procedure of implementing block 410 is the same as that of implementing block 102 in embodiment 1, so no further explanation is provided herein.

At block 411, the terminal removes equipment identifications included in the equipment identification areas where the second sliding track passes through from the target equipment group.

In at least one embodiment, when the terminal extracts the equipment identifications included in the equipment identification areas where the second sliding track passes through, the terminal can remove the equipment identifications included in the equipment identification areas where the second sliding track passes through. After it is done, the removed equipment identifications will not be shown in the target equipment group, but in the equipment list. For example, assume that a target equipment group includes equipment identification 1, equipment identification 2, equipment identification 3, equipment identification 4, and equipment identification 5. If the equipment identifications included in equipment identification areas where the second sliding track passes through include equipment identification 1 and equipment identification 4, after equipment identification 1 and equipment identification 4 are removed, the target equipment group is left with equipment identification 2, equipment identification 3, and equipment identification 5. Equipment identification 1 and equipment identification 4 will reappear in the equipment list.

At block 412, the terminal detects whether the number of equipment identifications included in the target equipment group is lower than a predetermined threshold. If yes, the terminal implements block 413; if no, the procedure ends here.

In at least one embodiment, after the terminal removes the equipment identifications included in the equipment identification areas where the second sliding track passes through from the target equipment group, the equipment identification in the target equipment list will become less and less. The terminal must determine whether the number of equipment identifications included in the target equipment group is lower than the predetermined threshold. If yes, the terminal would implement block 413; if no, the step ends here. The predetermined threshold can be any figure larger than zero, such as two, set by the user. For example, if the predetermined threshold is two, then after the terminal removes the equipment identifications included in the equipment identification areas where the second sliding track passes through from the target equipment group, the number of the equipment identification included in the target equipment group is one. Since one is smaller than two, the terminal can de-install the target equipment group, and the target equipment group will no longer exist in the equipment list.

At block 413, the terminal de-installs the target equipment group.

In the method described by the flow chart in FIG. 4, the terminal sends the play command including the duration and speed of the voice to the equipment corresponding to the equipment identification, so to control the equipment to start timing when receiving the play command, and start playing the song in accordance with the speed when the timing duration reaches the voice duration. Afterwards, the terminal can receive the enabling command for the target equipment group. The terminal then enables the interface of the target equipment group in response to the enabling command, and detects the second sliding track inputted into the interface of the target equipment group, so to extract the equipment identifications included in the equipment identification areas where the second sliding track passes through. When the terminal detects that the number of equipment identifications included in the target equipment group is lower than the predetermined threshold, the terminal de-stalls the target equipment group. Through the present embodiment, the terminal can remove equipment identifications from the target identification group in accordance with the operation commands inputted by the user. When the number of equipment identification in the target equipment group is lower than the predetermined threshold, the terminal de-installs the target equipment group so to adjust the equipment identification in the target equipment group, including de-installation of the target equipment group.

The following is a device embodiment of the present disclosure. The equipment embodiment of the present disclosure is configured to realize the methods described in the method embodiment 1, embodiment 3 and embodiment 4. For the convenience of explanation, the following equipment embodiment only describes the parts related to the embodiments of the present disclosure. For specific technical details, please refer to embodiment 1, embodiment 3 and embodiment 4.

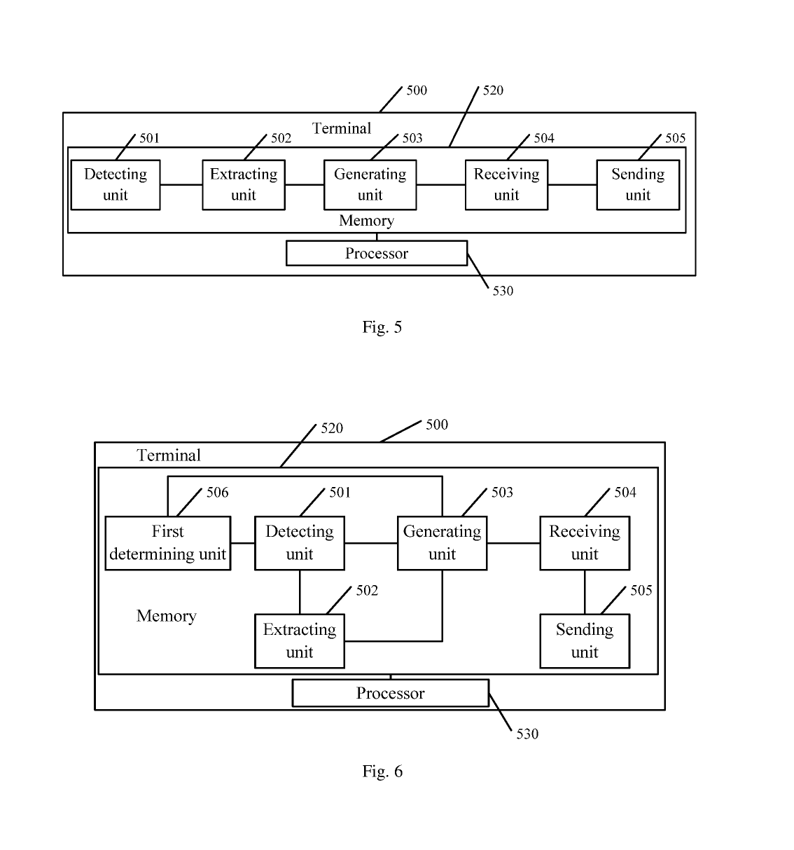

FIG. 5 is a block diagram of a terminal according to a first embodiment of the present disclosure. A terminal 500 includes a detecting unit 501, an extracting unit 502, a generating unit 503, a receiving unit 504 and a sending unit 505.

The detecting unit 501 is configured to detect the first sliding track inputted into the interface of the equipment list.

In at least one embodiment of the present disclosure, the detecting unit 501 can be configured to detect a first sliding track inputted at any position on the interface of the equipment list. For example, the detecting unit 501 can be configured to detect a first sliding track starting from a target touch point on the interface of the equipment list. The detecting unit 501 can also be configured to detect a first sliding track starting from any point other than the target touch point on the interface of the equipment list.

Please also refer to FIG. 2, FIG. 2 is a diagram showing different sliding tracks inputted into the interface of the equipment list according to the embodiment of the present disclosure. A first sliding track can be a regular sliding track, such as track a2 shown in part 2a of FIG. 2, and track c2 shown in part 2c of FIG. 2. The first sliding track can also be a curved sliding track, such as tracks a1 and a3 shown in part 2a of FIG. 2, tracks b1 and b2 shown in part 2b of FIG. 2, and tracks c1 and c3 shown in part 2c of FIG. 2.

The extracting unit 502 is configured to extract the equipment identifications included in the equipment identification areas where the first sliding track passes through.

In at least one embodiment, all equipment identifications are shown in the equipment identification areas. The equipment identifications are an exclusive string of alphabets or numbers configured to identify the equipment. Each equipment has one, and only one identification. The identification can be the user's nickname or contact information, the IMEI of the equipment, MAC address, or equipment ID. The present disclosure does not impose any specific requirement here.

In the embodiments of the present disclosure, when the user inputs a first sliding track into the interface of the equipment list, the first sliding track will pass through areas corresponding to some equipment identifications, which can be extracted by the extracting unit 502. For example, in FIG. 2, the equipment identifications included in the areas where sliding tracks a1, a2 and a3 in 2a pass through are speaker 1 and speaker 2; the equipment identifications included in the areas where sliding tracks b1 and b2 in 2b pass through are speaker 1 and speaker 3; and the equipment identifications included in the areas where sliding tracks c1, c2 and c3 in 2c pass through are speaker 1, speaker 2 and speaker 3.

The equipment identification areas only account for a part of the interface of the equipment list. These equipment identification areas can be divided evenly in accordance with the amount of the equipment identifications, so that each equipment identification only corresponds to a sub-area after the division. When the user is scrolling down the interface of the equipment list, the sub-area of an equipment identification can be skipped. For example, in FIG. 2, both sliding tracks b1 and b2 in 2b circumvent the sub-area of speaker 2, meaning that the equipment identification areas that b1 and b2 pass through do not include speaker 2.

The generating unit 503 is configured to generate a target equipment group including the equipment identification.

In the embodiment of the present disclosure, the target equipment group generated by the generating unit 503 includes all equipment identifications extracted by the extracting unit 502, meaning that these equipment identifications have been grouped into the target equipment group. For example, in FIG. 2, equipment identifications of speaker 1 and speaker 2 included in areas where sliding tracks a1, a2 and a3 in 2a passed through can generate the target equipment group; alternatively, equipment identifications of speaker 1 and speaker 2 included in areas where sliding tracks b1 and b2 in 2b passed through can generate the target equipment group; and still alternatively equipment identifications of speaker 1, speaker 2 and speaker 3 included in areas where sliding tracks c1, c2 and c3 in 2c passed through can also generate the target equipment group.

The receiving unit 504 is configured to receive and analyze voice messages inputted to the target equipment group, so to extract the duration and speed of the voice corresponding to voice messages.

In the embodiment of the present disclosure, after the generating unit 503 generates the target equipment group, the receiving unit 504 can receive voice messages inputted to target equipment group, and, furthermore, analyze the voice messages so that the terminal can extract the duration and speed of the voice corresponding to the voice messages.

For example, after the terminal enables the audio receiving equipment, the terminal receives song(s) sung by the user to the target equipment group. The terminal can then analyze the audio data corresponding to the songs and extract the duration and speed of the voice. If the song is five minutes long and at a speed of 1 Mb/s, then the terminal will render five minutes as the duration of the voice and 1 Mb/s as the speed of the voice after the terminal runs the analysis.

The sending unit 505 is configured to send a play command including the duration and speed of the voice to the equipment corresponding to the equipment identification, so to control the equipment to start timing when receiving the play command, and start playing the song in accordance with the speed when the timing duration reaches the voice duration.

In at least one embodiment, after the receiving unit 504 receives the duration and speed of the voice, the sending unit 505 can send a play command to equipment corresponding to equipment identification. The play command includes the duration and speed of the voice. Upon receiving the play command, the equipment enables a timer to time. When the timing duration reaches the voice duration, the terminal starts to play the song in accordance with the voice speed. The initial value of the timer is 0.

For example, if the duration of the voice is five minutes and the speed of the voice is 1 Mb/s, and the time when the equipment receives the play command is 11 AM, then the equipment will start playing the song starting from 11:05 AM at a speed of 1 Mb/s.

Please refer to FIG. 6, FIG. 6 is a block diagram of another terminal according to a second embodiment of the present disclosure. The terminal in FIG. 6 is an optimized version of the terminal shown in FIG. 5. Comparing with the terminal in FIG. 5, the terminal in FIG. 6 includes all units of the terminal in FIG. 5 and further includes a first determining unit 506. In FIG. 6, the detecting unit 501 is further configured to detect touch operations of a target touch point on the interface of the equipment list.

In at least one embodiment, the location of target touch point can be any points on the interface of the equipment list, such as a point outside or inside the equipment identification area. The present disclosure does not specify any location for the target touch points.

The first determining unit 506 is configured to decide whether the duration of the touch operation exceeds a predetermined time threshold.

In the embodiment of the present disclosure, the detecting unit 501 detects the duration of the touch operation of target touch points undertaken by the user on the interface of the equipment list, and the first determining unit 506 decides whether the duration exceeds the predetermined time threshold, which can be one, two or three seconds. The present disclosure does not specify any fixed time duration here.

The generating unit 503 is further configured to generate equipment grouping commands when the first determining unit 506 decides that the duration of the touch operation exceeds the predetermined time threshold.

A practical way the abovementioned detecting unit 501 detects the first sliding track inputted into the interface of the equipment list is the following:

The detecting unit 501, in response to the equipment grouping command, detects the first sliding tack starting from a target touch point on the interface of the equipment list.

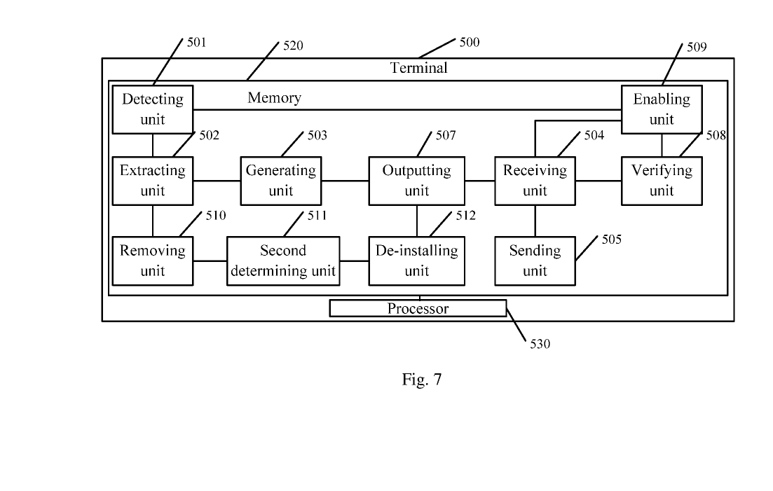

Please refer to FIG. 7. FIG. 7 is a block diagram of another terminal according to a third embodiment of the present disclosure. The terminal of FIG. 7 is an optimized version of the terminal of FIG. 5. Comparing with the terminal of FIG. 5, the terminal of FIG. 7 includes all units of the terminal of FIG. 5 and further includes an outputting unit 507, a verifying unit 508 and an enabling unit 509. In FIG. 7, the receiving unit 504 is further configured to receive an inputted equipment list enabling command before the detecting unit 501 detects the first sliding track inputted into the interface of the equipment list. The outputting unit 507 is configured to output a prompting message to request the input of a message pending verification. The receiving unit 504 is further configured to receive and respond to the message pending verification inputted by the prompting message. The verifying unit 508 is configured to verify whether the message pending verification is the same as a predetermined verification message. The enabling unit 509 is configured to enable the interface of the equipment list in response to the equipment list enabling command, when the verifying unit 508 verifies that the message pending verification is the same as the predetermined verification message.

In at least one embodiment, when the receiving unit 504 receives the equipment list enabling command, the outputting unit 507 outputs the prompting message that requests the input of the message pending verification. The outputting unit 507 can further be configured to output an entry gate of the message pending verification that is configured for inputting the message pending verification.

In at least one embodiment, the message pending verification can include but is not limited to, one or a combination of several of the following information, including password pending verification, finger print data pending verification, facial feature data pending verification, iris data pending verification, retina data pending verification, and voiceprint data pending verification.

In at least one embodiment, the predetermined verification message can include but is not limited to one of or a combination of several of the following information, such as predetermined verification password, predetermined fingerprint data, predetermined facial feature data, predetermined iris data, predetermined retina data and predetermined voiceprint data.

In at least one embodiment, the abovementioned predetermined verification message can include fingerprint string data and an input timing corresponding to each fingerprint. Accordingly, the verifying unit 508 verifies whether messages pending verification is the same as the predetermined verification messages through following steps.

The verifying unit 508 verifies whether the fingerprint string is the same as the fingerprint included in the predetermined verification message and whether intervals between input timings of the same fingerprints are smaller than the predetermined value. If the result shows that the fingerprint strings are the same as the fingerprint strings included in the predetermined verification message, and the intervals between input timings of the same fingerprints are smaller than the predetermined value, then it means that the message pending verification is the same as the predetermined verification message. If not, the message pending verification is not the same as the predetermined verification message. At least one embodiment can prevent the illegal user from enabling the interface of equipment list and command the interface at their will.

In another embodiment, the abovementioned outputting unit 507 is further configured to output the identifications of target equipment group in the equipment list after the abovementioned generating unit 503 generates the target equipment group and before the abovementioned receiving unit 504 receives and analyzes voice messages inputted to target equipment group so to extract the duration and speed of the voice corresponding to the voice messages. The target equipment group is positioned before ungrouped equipment identification(s) on the equipment list.

As an alternative embodiment, the terminal of FIG. 7 can further include a removing unit 510.

The receiving unit 504 is further configured to receive an enabling command for the target equipment group.

The enabling unit 509 is further configured to enable the interface of the target equipment group in response to the enabling command.

The detecting unit 501 is further configured to detect a second sliding track inputted into the interface of the target equipment group.

The extracting unit 502 is further configured to extract the equipment identifications included in the equipment identification areas where the second sliding track passes through.

The removing unit 510 is configured to remove the equipment identifications included in the equipment identification areas where the second sliding track passes through from the target equipment group.

In the embodiments of the present disclosure, after the extracting unit 502 extracts the equipment identifications included in the equipment identification areas where the second sliding track passes through, the removing unit 510 can remove the equipment identifications included in the equipment identification areas where the second sliding track passes through from the target equipment group. After the removal is done, the removed equipment identifications will no longer appear in the target equipment group but in the equipment list. For example, assume that a target equipment group includes equipment identification 1, equipment identification 2, equipment identification 3, equipment identification 4, and equipment identification 5. If the equipment identifications included in the equipment identification areas where the second sliding track passes through is equipment identification 1 and equipment identification 4, after equipment identification 1 and equipment identification 4 are removed, the target equipment group is left with identification 2, equipment identification 3, and equipment identification 5. Equipment identification 1 and equipment identification 4 will reappear in the equipment list.

In other embodiments, the terminal of FIG. 7 can further include a second determining unit 511 and de-installing unit 512.

The second determining unit 511 is configured to decide whether the number of equipment identifications included in target equipment group is lower than the predetermined threshold after the removing unit 510 removes the equipment identifications included in the equipment identification areas where the second sliding track passes through from the target equipment group.

In at least one embodiment, after the removing unit 510 removes the equipment identifications included in the equipment identification areas where the second sliding track passes through from the target equipment group, the equipment identifications in the target equipment group will become less and less. The second determining unit 511 must decide whether the number of equipment identifications included in the target equipment group is lower than the predetermined threshold. If yes, the de-installing unit 512 de-installs the target equipment group; if no, the procedure ends here. The predetermined threshold can be any figure larger than zero, such as two, set by the user. For example, if the predetermined threshold is two, then after the terminal removes the equipment identifications included in the equipment identification areas where the second sliding track passes through from the target equipment group, the number of the equipment identification included in the target equipment group is one. Since one is smaller than two, the terminal can de-install the target equipment group, and the target equipment group will no longer exist in the equipment list.

The de-installing unit 512 is configured to de-install the target equipment group when the second determining unit 511 decides that the number of equipment identifications included in the target equipment group is lower than the predetermined threshold.

In a terminal 500 shown in FIG. 5, FIG. 6 and FIG. 7, the detecting unit 501 detects the first sliding track inputted into the interface of the equipment list. The extracting unit 502 extracts the equipment identifications included in the equipment identification areas where the first sliding track passes through. The generating unit 503 generates the target equipment group. Furthermore, the receiving unit 504 receives voice messages inputted to the target equipment group and analyzes the voice messages, so to extract the duration and speed of the voice corresponding to the voice messages. The sending unit 505 sends the play command including the duration and speed of the voice to the equipment corresponding to the equipment identifications, so to control the equipment to start timing when receiving the play command, and start playing the song in accordance with the speed for a time duration the same as the voice duration.

The embodiments of the present disclosure further provide an equipment, e.g. the terminal 500 provided in FIGS. 5 through 7, including one or more processors 530, a memory 520 connected with the one or more processors 530, and one or more instructions stored in the memory 520. The detecting unit 501, the extracting unit 502, the generating unit 503, the receiving unit 504, the sending unit 505, the first determining unit 506, the outputting unit 507, the verifying unit 508, the enabling unit 509, the removing unit 510, the second determining unit 511, and the de-installing unit 512 are all programmed as the one or more program instructions stored in the memory 520. When the one or more program instructions are executed by the one or more processors 530, the units 501-512 are configured to cause the one or more processors 530 to perform their corresponding functions as disclosed above, so that the method of controlling play of the embodiments of the present disclosure is implemented.

The embodiments of the present disclosure further provide a nonvolatile computer storage medium. The computer storage medium stores the one or more instructions, which are to be executed so that the equipment can implement the method of controlling play of the embodiment of the present disclosure.

Through the terminal disclosed in the embodiments of the present disclosure, after dividing the equipments in the equipment list into groups and generating target equipment group, the terminal can control the equipment in the target equipment group to start timing when receiving the play command, and start playing songs in accordance with the speed when the timing duration reaches the voice duration. The terminal synchronizes the playing of songs of a plurality of playing equipment included in the same equipment group, and enhances the effect when listening to the songs.

For the convenience of description, the methods in the embodiments of the present disclosure are described as a combination of a series of moves. However, technicians in the present field should know the application is not limited to the sequence of the moves described. Based on the present application, some blocks can be taken by another sequence or concurrently. Besides, technicians in the present field should also know that embodiments described in the present specification are preferred embodiments; the moves and units involved are not necessarily compulsory in the present application.

The description of abovementioned embodiments focuses on different parts in each embodiment. Please refer to related description of other embodiments if a part in one embodiment has not been elaborated.

One having ordinary skill in the art understands that all or some of the procedures introduced in the above-mentioned embodiments are performed through computer programs which command relevant hardware. All of the programs are stored in a computer-readable storage medium. The programs in operation include all of the procedures introduced in the above-mentioned embodiments. The storage medium is a diskette, a compact disc, a read-only memory (ROM), or a random access memory (RAM).

While the present disclosure has been described in connection with what is considered the most practical and preferred embodiments, it is understood that this disclosure is not limited to the disclosed embodiments but is intended to cover various arrangements made without departing from the scope of the broadest interpretation of the appended claims.

What is claimed is:

1. A method of controlling play, comprising:
detecting a first sliding track inputted into an interface of an equipment list;
extracting equipment identifications included in equipment identification areas where the first sliding track passes through;
generating a target equipment group comprising the equipment identifications;
receiving voice messages inputted to the target equipment group and analyzing the voice messages so to extract a duration and speed of the voice corresponding to the voice messages;
sending a play command comprising the duration and speed of the voice to the equipment corresponding to the equipment identifications, so to control the equipment to start timing when receiving the play command, and start playing songs in accordance with the voice speed when the timing duration reaches the voice duration.

2. The method of claim 1, wherein, before detecting the first sliding track inputted into the interface of the equipment list, the method further comprises:
detecting a touch operation of a target touch point on the interface of the equipment list;
detecting whether the duration of the touch operations exceed a predetermined time threshold;
generating an equipment grouping command when detecting that the touch operations exceed the predetermined time threshold; and
detecting the first sliding track inputted into the interface of the equipment list comprising:
detecting, in response to the equipment grouping command, the first sliding track starting from the target touch point on the interface of the equipment list.

3. The method of claim 1, wherein, after a step of generating the target equipment group comprising the equipment identifications and before a step of receiving voice messages inputted to the target equipment group and analyzing the voice messages so to extract a duration and speed of the voice corresponding to the voice messages, the method further comprises:
outputting identifications of the target equipment group in the equipment list, wherein the target equipment group is positioned before ungrouped equipment identification.

4. The method of claim 3, wherein the method of sending the play command comprising the duration and speed of the voice to the equipment corresponding to the equipment identifications, so to control the equipment to start timing when receiving the play command, and start playing songs in accordance with the speed when the timing duration reaches the voice duration further comprises:
receiving an enabling command to the target equipment group;
enabling the interface of the target equipment group in response to the enabling command;
detecting the second sliding track inputted into the interface of the target equipment group;
extracting the equipment identifications included in the equipment identification areas where the second sliding track passed through; and
removing the equipment identifications included in the equipment identification areas where the second sliding track passed through from the target equipment group.

5. The method of claim 4, wherein, after removing the equipment identifications included in the equipment identification areas where the second sliding track passed through, the method further comprises:
detecting whether the number of equipment identifications included in the target equipment group is lower than the predetermined threshold; and
de-installing the target equipment group when detecting that the number of equipment identifications included in the target equipment group is lower than the predetermined threshold.

6. A terminal, comprising:
a detecting unit, configured to detect a first sliding track inputted into an interface of an equipment list;
an extracting unit, configured to extract equipment identifications included in equipment identification areas where the first sliding track passes through;
a generating unit, configured to generate a target equipment group comprising the equipment identifications;
a receiving unit, configured to receive voice messages inputted to the target equipment group and analyzing the voice messages so to extract a duration and speed of the voice corresponding to the voice messages;
a sending unit, configured to send a play command comprising the duration and speed of the voice to the equipment corresponding to the equipment identifications, so to control the equipment to start timing when receiving the play command, and start playing songs in accordance with the speed when the timing duration reaches the voice duration.

7. The terminal of claim 6, wherein the detecting unit is further configured to detect a touch operation of a target touch point on the interface of the equipment list; the terminal further comprises:
a first determining unit, configured to decide whether the duration of the touch operations exceed a predetermined time threshold;
the generating unit, configured to generate an equipment grouping command when detecting that the touch operations exceed the predetermined time threshold;
wherein the detecting unit configured to detect the first sliding track inputted into the interface of the equipment list, is specifically configured for:
detecting, in response to the equipment grouping command, the first sliding track starting from the target touch point on the interface of the equipment list.

8. The terminal of claim 6, further comprising:
an outputting unit, configured to output identifications of the target equipment group in the equipment list, after the target equipment group are generated and before the voice messages inputted to the target equipment group are received and analyzed so to extract the duration and speed of the voice corresponding to the voice messages, wherein the target equipment group is positioned before ungrouped equipment identification.

9. The terminal of claim 8, wherein the receiving unit is further configured for receiving an enabling command to the target equipment group;
the terminal further comprises:
an enabling unit, configured for enabling the interface of the target equipment group in response to the enabling command;
the detecting unit, configured for detecting the second sliding track inputted into the interface of the target equipment group;
the extracting unit, configured for extracting the equipment identifications included in the equipment identification areas where the second sliding track passed through;
a removing unit, configured for removing the equipment identifications included in the equipment identification areas where the second sliding track passed through from the target equipment group.

10. The terminal of claim 9 further comprising:
a second determining unit, configured for deciding whether the number of equipment identifications included in the target equipment group is lower than the predetermined threshold, after removing the equipment identifications included in the equipment identification areas where the second sliding track passed through;
a de-installing unit, configured for de-installing the target equipment group when detecting that the number of equipment identifications included in the target equipment group is lower than the predetermined threshold.

11. An equipment comprising:
one or more processors;
a memory;
one or more program instructions, stored in the memory and executable by the one or more processors to perform a method of controlling play, comprising:
detecting a first sliding track inputted into an interface of an equipment list;
extracting equipment identifications included in equipment identification areas where the first sliding track passes through;
generating a target equipment group comprising the equipment identifications;
receiving voice messages inputted to the target equipment group and analyzing the voice messages so to extract a duration and speed of the voice corresponding to the voice messages;
sending a play command comprising the duration and speed of the voice to the equipment corresponding to the equipment identifications, so to control the equipment to start timing when receiving the play command, and start playing songs in accordance with the voice speed when the timing duration reaches the voice duration.

12. The equipment of claim 11, wherein, before detecting the first sliding track inputted into the interface of the equipment list, the method further comprises:
detecting a touch operation of a target touch point on the interface of the equipment list;
detecting whether the duration of the touch operations exceed a predetermined time threshold;
generating an equipment grouping command when detecting that the touch operations exceed the predetermined time threshold; and
detecting the first sliding track inputted into the interface of the equipment list comprising:
detecting, in response to the equipment grouping command, the first sliding track starting from the target touch point on the interface of the equipment list.

13. The equipment of claim 11, wherein, after a step of generating the target equipment group comprising the equipment identifications and before a step of receiving voice messages inputted to the target equipment group and analyzing the voice messages so to extract a duration and speed of the voice corresponding to the voice messages, the method further comprises:
outputting identifications of the target equipment group in the equipment list, wherein the target equipment group is positioned before ungrouped equipment identification.

14. The equipment of claim 13, wherein the method of sending the play command comprising the duration and speed of the voice to the equipment corresponding to the equipment identifications, so to control the equipment to start timing when receiving the play command, and start playing songs in accordance with the speed when the timing duration reaches the voice duration further comprises:
receiving an enabling command to the target equipment group;
enabling the interface of the target equipment group in response to the enabling command;
detecting the second sliding track inputted into the interface of the target equipment group;
extracting the equipment identifications included in the equipment identification areas where the second sliding track passed through; and
removing the equipment identifications included in the equipment identification areas where the second sliding track passed through from the target equipment group.

15. The equipment of claim 14, wherein, after removing the equipment identifications included in the equipment identification areas where the second sliding track passed through, the method further comprises:
detecting whether the number of equipment identifications included in the target equipment group is lower than the predetermined threshold; and
de-installing the target equipment group when detecting that the number of equipment identifications included in the target equipment group is lower than the predetermined threshold.

16. The equipment of claim 11, wherein the one or more program instructions comprise:
a detecting unit, configured to cause the one or more processors to detect a first sliding track inputted into an interface of an equipment list;
an extracting unit, configured to cause the one or more processors to extract equipment identifications included in equipment identification areas where the first sliding track passes through;
a generating unit, configured to cause the one or more processors to generate a target equipment group comprising the equipment identifications;
a receiving unit, configured to cause the one or more processors to receive voice messages inputted to the target equipment group and analyzing the voice messages so to extract a duration and speed of the voice corresponding to the voice messages;
a sending unit, configured to cause the one or more processors to send a play command comprising the duration and speed of the voice to the equipment corresponding to the equipment identifications, so to control the equipment to start timing when receiving the play command, and start playing songs in accordance with the speed when the timing duration reaches the voice duration.

17. The equipment of claim 16, wherein the detecting unit is further configured to cause the one or more processors to detect a touch operation of a target touch point on the interface of the equipment list; the one or more program instructions further comprise:
a first determining unit, configured to cause the one or more processors to decide whether the duration of the touch operations exceed a predetermined time threshold;
the generating unit, configured to cause the one or more processors to generate an equipment grouping command when detecting that the touch operations exceed the predetermined time threshold;
wherein the detecting unit configured to cause the one or more processors to detect the first sliding track inputted into the interface of the equipment list, is specifically configured to cause the one or more processors to detect, in response to the equipment grouping command, the first sliding track starting from the target touch point on the interface of the equipment list.

18. The equipment of claim 16, wherein the one or more program instructions further comprise:
an outputting unit, configured to cause the one or more processors to output identifications of the target equipment group in the equipment list, after the target equipment group are generated and before the voice messages inputted to the target equipment group are received and analyzed so to extract the duration and speed of the voice corresponding to the voice messages, wherein the target equipment group is positioned before ungrouped equipment identification.

19. The equipment of claim 18, wherein the receiving unit is further configured to cause the one or more processors to receive an enabling command to the target equipment group;
the one or more program instructions further comprise:
an enabling unit, configured to cause the one or more processors to enable the interface of the target equipment group in response to the enabling command;
the detecting unit, configured to cause the one or more processors to detect the second sliding track inputted into the interface of the target equipment group;
the extracting unit, configured to cause the one or more processors to extract the equipment identifications included in the equipment identification areas where the second sliding track passed through;
a removing unit, configured to cause the one or more processors to remove the equipment identifications included in the equipment identification areas where the second sliding track passed through from the target equipment group.

20. The equipment of claim 19, wherein the one or more program instructions further comprise:
a second determining unit, configured to cause the one or more processors to decide whether the number of equipment identifications included in the target equipment group is lower than the predetermined threshold, after removing the equipment identifications included in the equipment identification areas where the second sliding track passed through;
a de-installing unit, configured to cause the one or more processors to de-install the target equipment group when detecting that the number of equipment identifications included in the target equipment group is lower than the predetermined threshold.
